(19) United States
(12) Patent Application Publication
(10) Pub. No.: US 2026/0180023 A1
(43) Pub. Date: Jun. 25, 2026

(54) NOVEL ALL-SOLID-STATE ELECTROLYTES BASED ON ORGANOBORON COVALENT ORGANIC NETWORKS

(71) Applicants: CENTRE NATIONAL DE LA RECHERCHE SCIENTIFIQUE, Paris (FR); UNIVERSITE DE PICARDIE JULES VERNE, Amiens Cedex 1 (FR)

(72) Inventors: Boris IRIÉ-BI, Amiens (FR); Matthieu BECUWE, Bernaville (FR); Franck DOLHEM, La Vicogne (FR)

(21) Appl. No.: 19/128,636

(22) PCT Filed: Nov. 9, 2023
(86) PCT No.: PCT/EP2023/081336

§ 371 Date: May 9, 2025

(30) Foreign Application Priority Data
Nov. 10, 2022 (FR) 2211761

(51) Int. Cl. H01M 10/0562; H01M 10/052; H01M 10/0525; H01M 10/0568; H01M 10/42

(52) U.S. Cl. CPC H01M 10/0562; H01M 10/052; H01M 10/0525; H01M 10/0568; H01M 10/4235; H01M 2300/0071

(57) ABSTRACT

An organoboron covalent organic network impregnated with at least one salt selected from alkali metal salts and alkaline-earth metal salts. The impregnated organoboron covalent organic network is substantially free of organic solvent. A method for preparing an impregnated organoboron covalent organic network, the use thereof as a solid electrolyte in an all-solid-state battery, and a separator for an all-solid-state battery, an electrode for an all-solid-state battery and an all-solid-state battery comprising such an impregnated organoboron covalent organic network.

The present invention relates to an organoboron covalent organic framework (or organoboron COF) impregnated with at least one salt, selected from alkali metal salts and alkaline-earth metal salts. The present invention also relates to a method for preparing such an impregnated organoboron covalent organic framework. The present invention also relates to the use of such an impregnated organoboron covalent organic framework as a solid electrolyte in an all-solid-state battery, as well as an all-solid-state battery separator, an all-solid-state battery electrode and an all-solid-state battery comprising such an impregnated organoboron covalent organic framework.

“Conventional” lithium batteries have high energy densities and are used in many everyday objects (e.g. electric vehicles, portable electronic devices). Lithium batteries are based on the reversible exchange of lithium ions between a positive electrode and a negative electrode, which are separated by an ion-conductive electrolyte. Traditionally, electrolytes are organic solvents mixed with lithium salts. However, they have the disadvantages of being toxic, flammable and can compromise battery safety, for example due to explosion hazards.

US 2019/284212 and CN 114 094 172 both describe organoboron covalent organic frameworks impregnated with a lithium salt, as well as with a significant amount of organic solvent, usable as battery electrolytes.

It is necessary to develop safer batteries, while maintaining or even improving the performance of known batteries, particularly those with high ion conductivity at the operating temperature.

Li-polymer batteries are currently a promising alternative for battery safety while bringing new properties (flexibility, for example) and freeing themselves from some critical resources. PEO technology is one of the embodiments in the field. However, although this technology has made it possible to build efficient batteries, current performance is limited by the operating temperature (60° C.) and the recyclability of the electrolyte at the end of the battery's life.

There is therefore a need for new all-solid-state electrolyte materials.

In particular, there is a need for all-solid-state electrolyte materials with high ion conductivity. In particular, there is a need for all-solid-state electrolyte materials having high ion conductivity over a wide operating temperature range, it being understood that, for application as an ionic electrolyte, these materials must have the lowest possible electronic conductivity.

There is also a need for all-solid-state electrolyte materials with better recyclability than current electrolytes.

It has been discovered by the present inventors that, quite surprisingly, these objectives are achieved by a material with a particular structure, more precisely, a material based on an organoboron covalent organic framework impregnated with a specifically selected salt, and, unlike the ionic electrolyte materials proposed by the prior art, free of organic solvent. Nothing in the prior art suggested such a result.

The present invention therefore relates to an organoboron covalent organic framework impregnated with at least one salt selected from alkali metal salts and alkaline-earth metal salts.

The present invention relates more specifically to an organoboron covalent organic framework impregnated with at least one salt selected from alkali metal salts and alkaline-earth metal salts, the impregnated organoboron covalent organic framework being substantially free of organic solvent.

A covalent organic framework is known by the acronym COF.

A covalent organic framework is a porous, crystalline, two- or three-dimensional material prepared by bonding light elements (e.g., B, C, N, O) by covalent bonds periodically. A covalent organic framework is therefore composed of an elementary unit repeated periodically.

An organoboron compound is, according to the invention, an organic compound having at least one bond between a carbon atom and a boron atom.

An organoboron covalent organic framework according to the invention is therefore a covalent organic framework whose elementary unit comprises at least one boron atom.

According to the invention, “substantially free of organic solvent” means that the impregnated organoboron covalent organic framework comprises less than 5% by weight of organic solvent relative to the total weight of the impregnated organoboron covalent organic framework, preferably less than 2% by weight, preferably less than 1% by weight, preferably less than 0.5% by weight, more preferably less than 0.1% by weight. Advantageously, the impregnated organoboron covalent organic framework is totally free of organic solvent.

In the context of the present invention, the term organic “solvent” includes ionic liquids, which, as is known to the person skilled in the art, have all the characteristics required for the characterization of a substance as an organic solvent.

The organic solvent is, for example, polar. The organic solvent is, for example, acetone, ethyl acetate, acetonitrile, dimethylformamide, dimethoxyethane, dioxane, triethylamine, tetrahydrofuran, dimethylsulfoxide, N—N-dimethylacetamide, N-methyl-2-pyrrolidone, N-ethyl-2-pyrrolidone, and N-octylpyrrolidone, methanol, ethanol, isopropyl alcohol, diethyl ether, diisopropyl ether, methyl tertiobutyl ether, methyl tetrahydrofuran or 2-ethoxy-2-methylpropane.

The impregnated organoboron covalent organic framework according to the invention is in particular substantially free of tetrahydrofuran. According to the invention, “substantially free of tetrahydrofuran” means that the impregnated organoboron covalent organic framework comprises less than 5% by weight of tetrahydrofuran relative to the total weight of the impregnated organoboron covalent organic framework, preferably less than 2% by weight, preferably less than 1% by weight, preferably less than 0.5% by weight, more preferably less than 0.1% by weight. Advantageously, the impregnated organoboron covalent organic framework is totally free of tetrahydrofuran.

The impregnated organoboron covalent organic framework according to the invention is also substantially free of ionic liquid. According to the invention, “substantially free of ionic liquid” means that the impregnated organoboron covalent organic framework comprises less than 5% by weight of ionic liquid relative to the total weight of the impregnated organoboron covalent organic framework, preferably less than 2% by weight, preferably less than 1% by weight, preferably less than 0.5% by weight, more preferably less than 0.1% by weight. Advantageously, the impregnated organoboron covalent organic framework is totally free of ionic liquid.

Preferably, the impregnated organoboron covalent organic framework according to the invention has a specific surface area greater than or equal to 50 m²/g, preferably greater than or equal to 250 m²/g, preferably greater than or equal to 500 m²/g, and in particular greater than or equal to 500 m²/g. The specific surface area of the impregnated organoboron covalent organic framework according to the invention is preferably from 50 to 3000 m²/g, preferably from 400 to 1600 m²/g, and in particular from 500 to 1600 m²/g.

The specific surface area can be determined by N₂ adsorption: the analysis of N₂ gas adsorption isotherms can be performed using a Micromeritics porosimetry analyzer ASAP 2020, a Micromeritics porosimetry analyzer. The measurement is carried out at 77 K (liquid N₂ bath) on 300 mg samples that have been degassed and activated.

Preferably, the impregnated organoboron covalent organic framework according to the invention has a pore diameter greater than or equal to 1.0 nm, preferably greater than or equal to 1.5 nm, preferably greater than or equal to 2.0 nm, preferably between 1.0 and 5.0 nm, preferably between 2.0 and 3.0 nm.

The pore diameter can be determined from nitrogen adsorption isotherms, for example at 77 K, according to the BJH method (Barret-Joyner-Halenda).

Advantageously, the impregnated organoboron covalent organic framework according to the invention degrades in the presence of water. When used as an electrolyte in a battery, this instability in the presence of water allows for much easier recycling of the electrolyte than with prior art electrolytes.

### Organoboron Covalent Organic Framework

The covalent organic framework is preferably two-dimensional or three-dimensional, preferentially two-dimensional.

The organoboron covalent organic framework preferably has the following formula (I):

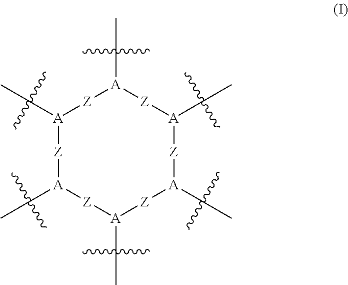

wherein
A is a monocyclic or polycyclic organoboron moiety, possibly substituted,
Z is a monocyclic or polycyclic organic moiety, possibly substituted,
and wherein each A-Z bond is a carbon-boron bond, or
the organoboron covalent organic framework has the following formula (II):

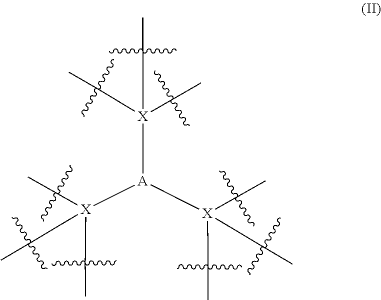

wherein
A is a monocyclic or polycyclic organoboron moiety, possibly substituted,
X is a monocyclic or polycyclic organic moiety, possibly substituted,
and wherein each A-X bond is a carbon-boron bond, or
the organoboron covalent organic framework is a spiroborate and has the following formula (III):

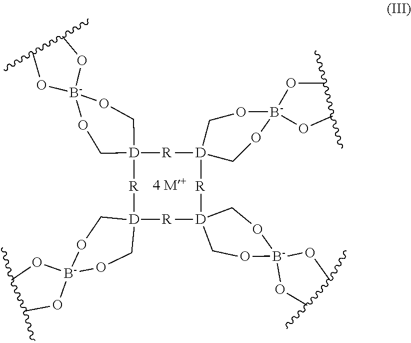

wherein
D is a monocyclic or polycyclic organic moiety, possibly substituted,
R is a linear organic moiety, possibly substituted, and
M′⁺ is a cation selected from metal, alkali metal or alkaline-earth metal cations, such as Li⁺, Na⁺, K⁺, Ca²⁺, Mg²⁺ or Al³⁺.

“Possibly substituted” means, for the entirety of the present application, preferably possibly substituted with at least one C1-C6, preferably C1-C3, alkyl group, the alkyl group being possibly interrupted by an oxygen atom and/or possibly comprising an anionic group, for example a carboxylate, sulfonate or phosphonate group, or a halogenated group, for example the trifluoromethanesulfonimide group.

The organoboron covalent organic frameworks of formula (I) and (III) are two-dimensional and the organoboron covalent organic frameworks of formula (II) are three-dimensional.

The organoboron covalent organic framework is preferably of formula (I).

In formula (I), each A-Z bond is preferably a bond between a boron atom of the moiety A and a carbon atom of the moiety Z.

In formula (II), each bond A-X is preferably a bond between a boron atom of the moiety A and a carbon atom of the moiety X.

The organoboron covalent organic framework preferably consists of carbon, hydrogen, boron and oxygen atoms, and optionally silicon.

According to the invention, a monocyclic compound is a compound comprising one ring, saturated or unsaturated, optionally comprising one or more heteroatoms, such as N or O.

According to the invention, a polycyclic compound is a compound comprising at least two rings, each ring being independently saturated or unsaturated, fused (having at least 2 atoms in common) with one or more of the other rings and/or separated from the other ring(s) by at least one chemical bond, and optionally comprising one or more heteroatoms, such as N or O.

In formula (I), each chemical bond A-Z preferably forms a boronic ester function. Each bond A-Z preferably corresponds to a bond between a carbon of the moiety Z and a boron of a B(O) 2 unit of the moiety A.

In formula (II), each chemical bond A-X preferably forms a boronic ester function. Each bond A-X preferably corresponds to a bond between a carbon of the moiety X and a boron of a B(O) 2 unit of the moiety A.

In formula (I) or (II), the moiety A is preferably chosen from a moiety of formula (A-1)

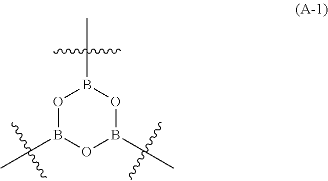 [SMILES: *B1OB(*)OB(*)O1]

and a moiety of formula (A-2)

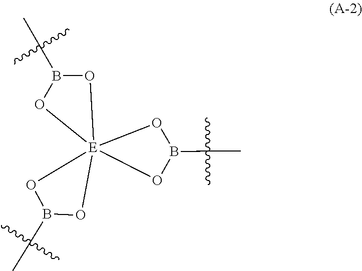

wherein E is a monocyclic or polycyclic, possibly substituted, preferably aromatic, hydrocarbon moiety.

E is preferably a moiety comprising one or more 6-membered hydrocarbon rings, each ring being independently saturated or comprising at least one unsaturation, preferably aromatic, and optionally substituted. E preferably comprises at least two 6-membered hydrocarbon aromatic rings, optionally substituted, each ring being independently fused (having 2 atoms in common) with one or more of the other rings and/or separated from the other ring(s) by at least one chemical bond. More preferably, E comprises at least three 6-membered hydrocarbon aromatic rings, optionally substituted, each ring being fused with at least one other ring, preferably with exactly one other ring. Advantageously, E comprises, preferably consists of, four 6-membered hydrocarbon aromatic rings, each ring being fused with at least one other ring, preferably with exactly one other ring.

Advantageously, the moiety A is selected from a moiety of formula (A-1)

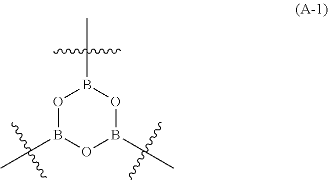 [SMILES: *B1OB(*)OB(*)O1]

and a moiety of formula (A-21)

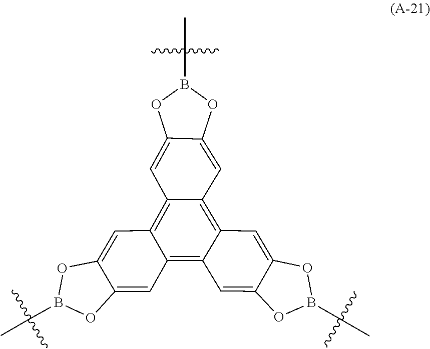

In formula (I), Z is preferably a moiety comprising one or more 6-membered hydrocarbon rings, each ring being independently saturated or comprising at least one unsaturation, preferably aromatic, and optionally substituted. Z preferably comprises one or more 6-membered hydrocarbon aromatic rings, optionally substituted, and when it comprises a plurality of rings, each ring is independently fused (has 2 atoms in common) with one or more of the other rings and/or separated from the other ring(s) by at least one chemical bond.

More preferably, Z comprises, preferably consists of, from 1 to 6, preferably from 1 to 4, preferably 1, 2 or 3 6-membered hydrocarbon aromatic rings, optionally each independently substituted, and when it comprises a plurality of rings, each ring being separated from the other ring(s) by at least one chemical bond, preferably by 1, 2 or 3 chemical bonds, so as to form a linear sequence of rings. Each ring is preferably separated from the other rings by exactly one carbon-carbon chemical bond, or by 3 chemical bonds chained linearly, the second chemical bond being a carbon-carbon or carbon-nitrogen double bond.

Advantageously, the moiety Z is selected from a moiety of formula (Z-1)

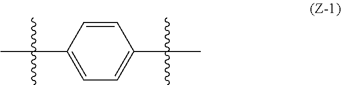 [SMILES: *c1ccc(*)cc1]

a moiety of formula (Z-2)

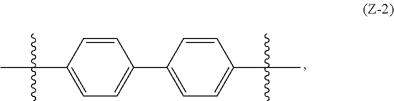 [SMILES: *c1ccc(-c2ccc(*)cc2)cc1]

a moiety of formula (Z-3)

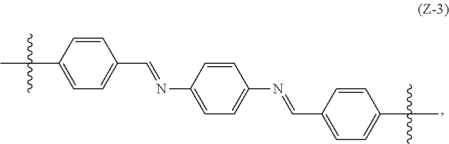 [SMILES: *c1ccc(/C=N/c2ccc(/N=C/c3ccc(*)cc3)cc2)cc1]

and a moiety of formula (Z-3′):

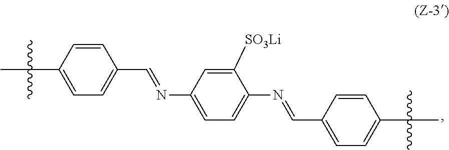

In formula (II), X is preferably a moiety comprising one or more 6-membered hydrocarbon rings, each ring being independently saturated or comprising at least one unsaturation, preferably aromatic, and optionally substituted. X preferably comprises at least two, preferably two to four, optionally substituted, 6-membered hydrocarbon aromatic rings, each ring being separated from the other ring(s) by at least one chemical bond, preferably all being connected to a same tetravalent atom, preferably to a same carbon or silicon atom. More preferably, X comprises, preferably consists of, four 6-membered hydrocarbon aromatic rings, each ring being connected to a same tetravalent atom, preferably at a carbon or silicon atom.

Advantageously, the moiety X is a moiety of formula (X-1):

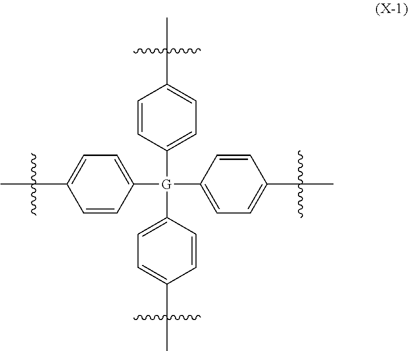

wherein G is a carbon atom or a silicon atom.

In formula (III), D is preferably a moiety comprising one or more 5- or 6-membered hydrocarbon rings, each ring being independently saturated or comprising at least one unsaturation, and optionally substituted. D preferably comprises 2 or 3 5- or 6-membered rings, each ring being independently fused (having 2 atoms in common) with one or more of the other rings.

Advantageously, D is a moiety of formula (G-1):

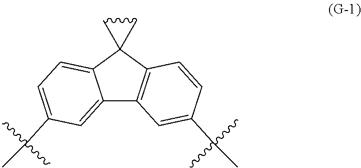

In formula (III), R is preferably a linear hydrocarbon moiety, saturated or comprising at least one unsaturation, comprising from 1 to 6 carbon atoms, preferably from 2 to 4, advantageously 2 carbon atoms. Advantageously, R is the —C═C— group.

The organoboron covalent organic framework is preferably selected from COF-1, COF-5, COF-10, the COF of formula (I) wherein A=(A-1) and Z=(Z-3), the COF of formula (I) wherein A=(A-1) and Z=(Z-3′), the COF of formula (I) wherein A=(A-21) and Z=(Z-3), the COF of formula (I) wherein A=(A-21) and Z=(Z-3′), the COF-102 (formula (II) where A=(A-1), X=(X-1) and G=C), COF-103 (formula (II) where A=(A-1), X=(X-1) and G=Si), COF-105 (formula (II) where A=(A-21), X=(X-1) and G=Si), COF-108 (formula (II) where A=(A-21), X=(X-1) and G=C) and the spiroborate COF of the following formula (III-A):

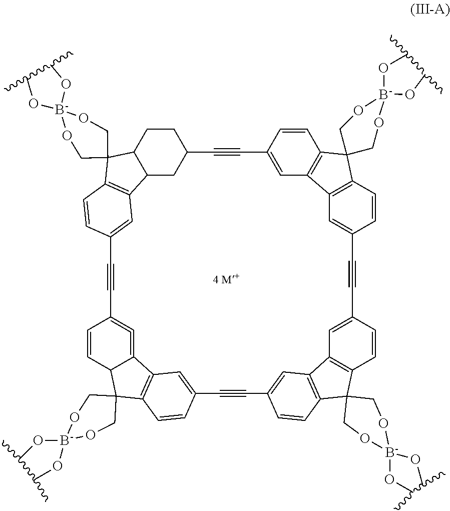

wherein M′⁺ is a cation selected from metal, alkali metal or alkaline-earth metal cations, such as Lit, Na⁺, K⁺, Ca²⁺, Mg²⁺ or Al³⁺.

The structures of the organoboron covalent organic frameworks COF-1, COF-5, COF-10, COF-102, COF-103, COF-105 and COF-108 are well known to the person skilled in the art.

More preferably, the organoboron covalent organic framework is selected from COF-1, COF-5 and COF-10, preferably is COF-5.

COF-1 is an organoboron covalent organic framework of formula (I) wherein A is of formula (A-1) and Z is of formula (Z-1) as defined above.

COF-5 is an organoboron covalent organic framework of formula (I) wherein A is of formula (A-21) and Z is of formula (Z-1) as defined above.

COF-10 is an organoboron covalent organic framework of formula (I) wherein A is of formula (A-21) and Z is of formula (Z-2) as defined above.

### Salt

The impregnated organoboron covalent organic framework according to the invention comprises at least one salt.

This salt is selected from alkali metal salts and alkaline-earth metal salts. It is preferably an alkali metal salt, preferably a lithium salt.

Preferably, the salt is a salt of formula MX₁, M being a metal cation selected from alkali metal cations and alkaline-earth metal cations, and X₁ being an anion comprising at least one halogen.

Preferably, M is a cation selected from Lit, Na⁺, K⁺, Mg²⁺ and Ca²⁺, advantageously is Li⁺.

Preferably, X₁ is selected from halide ions, preferably Br⁻ or I⁻, advantageously I⁻, perchlorate anion CIO4″, bis(trifluoromethanesulfonyl)imide anion (known as TFSI), bis(fluorosulfonyl)imide anion (known as FSI), hexafluorophosphate anion PF₆⁻, tetrafluoroborate anion BF₄⁻, bis(pentafluoroethanesulfonyl)imide anion (known as BETI), C1-C4 fluoroalkyl-4,5-dicyano-imidazolate anions, for example trifluoromethyl-4,5-dicyano-imidazolate anion or pentafluoroethyl-4,5-dicyano-imidazolate anion, more preferably halide ions, preferably Br⁻ or I⁻, more preferably I⁻, perchlorate anion CIO4; and bis(trifluoromethanesulfonyl)imide anion. Advantageously, X₁ is the ion I⁻.

The salt is preferably lithium iodide.

According to another embodiment, the salt is an ammonium ion salt, preferably quaternary ammonium, preferably a C1-C4 ammonium tetraalkyl salt, such as a tetramethyl ammonium salt, or a phosphonium ion salt, preferably a quaternary phosphonium salt, preferably a C1-C4 tetraalkyl phosphonium salt, such as a tetramethyl phosphonium salt. According to this embodiment, the anion of the salt is preferably a halide ion, preferably the iodide ion.

The impregnated organoboron covalent organic framework according to the invention preferably has a molar ratio between the molar amount of alkali metal or alkaline-earth metal, and the total molar amount of boron in the impregnated organoboron covalent organic framework, comprised between 0.05 and 10, preferably between 0.1 and 5, preferably between 0.2 and 4, preferably between 0.3 and 3.

The molar amounts of alkali metal or alkaline-earth metal and the molar amount of boron are defined in relation to the total amount of moles in the impregnated organoboron covalent organic framework, i.e. the molar amount of boron taken into account for the calculation of the ratio includes the boron contained in the organoboron covalent organic framework and the boron possibly contained in the salt.

The present invention also relates to a method for preparing an impregnated organoboron covalent framework according to the invention, comprising the following steps:
a step of supplying an organoboron covalent framework,
a step of adding to the organoboron covalent framework a salt selected from alkali metal salts and alkaline-earth metal salts, said salt being in solution in an organic solvent, and obtaining a mixture,
a step of stirring the mixture, and
a step of removing, entirely or substantially entirely, the organic solvent by drying the mixture, said drying being fractionated into at least a first drying step and a second drying step.

The organoboron covalent framework and the salt are preferably as defined above with respect to the impregnated organoboron covalent framework.

The stirring step is preferably performed for at least 120 hours, preferably at least 144 hours, preferably at least 168 hours, preferably between 120 hours and 340 hours. The step of removing the organic solvent is preferably carried out directly on the mixture, in particular without prior mechanical treatment thereof, such mechanical treatment being preferably also not carried out between the first drying step and the second drying step.

At least one step out of the first drying step and the second drying step is preferably performed at a temperature between 30° C. and 230° C., preferably between 30° C. and 180° C., preferably between 40° C. and 150° C., preferably between 50° C. and 130° C., preferably between 60° C. and 120° C.

The first drying step is preferably performed at a temperature between 15° C. and 30° C., preferably around 25° C. The first drying step is preferably performed under reduced pressure. The first drying step is preferably performed under an inert atmosphere. The first drying step is preferably performed for 5 hours to 36 hours, preferably for 6 hours to 24 hours, preferably for 10 hours to 20 hours.

The second drying step is preferably performed at a temperature between 40° C. and 180° C., preferably between 50° C. and 150° C., preferably between 60° C. and 130° C. The second drying step is preferably performed under reduced pressure. The second drying step is preferably performed under an inert atmosphere. The second drying step is preferably performed for 2 hours to 12 hours, preferably for 4 hours to 10 hours, preferably for 5 hours to 7 hours.

The drying preferably further comprises a third drying step.

The third drying step is preferably performed at a temperature between 80° C. and 180° C., preferably between 100° C. and 150° C., preferably between 110° C. and 130° C. The third drying step is preferably performed under reduced pressure. The third drying step is preferably performed under an inert atmosphere. The third drying step is preferably performed for 8 hours to 48 hours, preferably for 10 hours to 36 hours, preferably for 12 hours to 20 hours. According to this embodiment, the second drying step is preferably performed at a temperature between 30° C. and 100° C., preferably between 40° C. and 90° C., preferably between 50° C. and 80° C., preferably between 60° C. and 70° C. The second drying step is preferably performed under reduced pressure. The second drying step is preferably performed under an inert atmosphere. The second drying step is preferably performed for 2 hours to 12 hours, preferably for 4 hours to 10 hours, preferably for 5 hours to 7 hours.

“Under reduced pressure” means under a pressure between 1 mbar and 50 mbar, preferably between 3 mbar and 30 mbar, preferably between 5 mbar and 15 mbar.

“Under an inert atmosphere” preferably means an atmosphere comprising between 0.1 ppm and 10 ppm of O₂ and/or between 0.1 and 10 ppm of water.

The organic solvent is preferably polar.

The polar solvent is preferably different from tetrahydrofuran.

The organic solvent preferably has a boiling temperature at atmospheric pressure less than or equal to 65° C., preferably between 30° C. and 60° C., and/or a vapor pressure at 20° C. greater than 20 kPa, preferably between 23 and 40 kPa.

The organic solvent is, for example, selected from acetone, ethyl acetate, acetonitrile, dimethoxyethane, dioxane, N—N-dimethylacetamide, N-ethyl-2-pyrrolidone, and N-octylpyrrolidone, methanol, ethanol, isopropyl alcohol, diethyl ether, diisopropyl ether, methyltertiobutyl ether, methyl-tetrahydrofuran or 2-ethoxy-2-methylpropane, advantageously is acetone.

The present invention also relates to the use of an impregnated organoboron covalent framework according to the invention as a solid electrolyte in an all-solid-state battery.

The impregnated organoboron covalent framework is preferably used as a separator and/or as an electrolytic material of an all-solid-state battery electrode.

The all-solid-state battery can be of the Li-ion type, primary Li (non-rechargeable) and Li metal (rechargeable or not), dual-ion double electrolyte, Na-ion, K-ion, Mg-ion, or Ca-ion, or Na-metal, preferably in an Li-ion, primary Li, and Li metal type battery.

When used in a separator, the impregnated organoboron covalent framework may be used alone or in conjunction with one or more additional compounds, for example a binder, preferably a polymeric one.

When used as the electrolytic material of an all-solid-state battery electrode, the impregnated organoboron covalent framework may be used in conjunction with one or more conventionally used additional compounds, for example a positive or negative electrode active material, and optionally a binder and/or a conductive additive.

Said electron-conductive additive(s) may be chosen from carbon fibers, carbon black, carbon nanotubes, graphite, graphene, acetylene black and analogs thereof, metallic particles, e.g. silver or copper particles, conductive polymers, for example poly-p-phenylene, poly(3,4-ethylenedioxythiophene) (PEDOT), polyaniline (PANI) or polypyrrole, and charge transfer complexes, for example those of the tetrathiofulvalenium-tetracyanoquinodimethane (TTF-TCNQ) type.

The binder(s) may be chosen from fluorinated binders, in particular polytetrafluoroethylene and polyvinylidene fluoride, cellulose fibers, cellulose derivatives such as starch, carboxymethylcellulose and derivatives thereof, polysaccharides and latexes, in particular of styrene-butadiene rubber type.

The electrode can be either a positive electrode or a negative electrode. The term “negative electrode” means the electrode operating as an anode when the accumulator is discharging, and the term “positive electrode” means the electrode operating as a cathode when the accumulator is discharging.

Said positive electrode active material(s) are not particularly limited, and may be chosen from:
materials capable of inserting lithium ions in a reversible manner which may be chosen from oxides such as LiₓMO₂ (0.5≤x≤3), wherein M represents at least one metal element selected from the group comprising Ni, Co, Mn, Fe, Cr, Ti, Cu, V, Al and Mg and vanadates such as LixV₂O₅ (0≤x≤5) or LiₓV₃O₈ (1≤x≤3), phosphates such as LiFePO₄, Li₃Fe₂ (PO₄)₃, LiV₂(PO₄)₃; silicates such as Li₂FeSiO₄, borates such as LiFeBO₃ and sulfonates such as LiFeSO₄F, Li₂Fe₂ (SO₄)₃
materials capable of inserting lithium ions in a reversible manner which may be chosen from oxides of formula Li_{1+y+z/3} Ti_{2-z/3} O₄ (0<z<1, 0<y<1), Li_{4+z′} Ti₅ O₁₂ (0<z′<3), carbon and carbon products from pyrolysis of organic materials, as well as organic carboxylates such as terephthalates;
organic electrode materials, such as benzoquinone and derivatives thereof, 7,7,8,8-tetracyano-p-quinodimethane and derivatives thereof, oximates, sulfonimides, perylene diimides and dianhydrides.

Said negative electrode active material(s) are not particularly limited, and may be chosen from carbon materials, in particular hard carbon, soft carbon, carbon nanofibers or carbon felt, antimony, tin, and phosphorus.

The present invention also relates to the use of an impregnated organoboron covalent framework according to the invention as an additive in an electrolyte composition.

The electrolyte composition may comprise:
a solution of alkali metal or alkaline-earth salt, said salt being as defined above, for example LiI, the salt being in solution in a solvent conventionally used in electrolyte compositions, for example N-methylpyrrolidone (NMP) or acetone, or
an oxygenated polymer such as polyethylene oxides, PEO (5-100000), a polymer including an immobilized trifluoromethylsulfonyl)imide (TFSI) moiety, such as poly(4-styrenesulfonyl(trifluorosulfonyl)imide) (PSTFSI), or
a sulfide-type ceramic material such as argyrodite.

The presence of the impregnated organoboron covalent framework according to the invention in the electrolyte composition advantageously improves the electrochemical performance of the composition. For example, when the impregnated organoboron covalent framework is associated with a conductive polymer, cooperation is observed, in particular in terms of conductivity, between the impregnated organoboron covalent framework and the conductive polymer.

The present invention therefore also relates to an electrolyte composition comprising an impregnated organoboron covalent organic framework according to the invention.

This composition may, in addition to the impregnated organoboron covalent organic framework, further comprise an alkali or alkaline-earth metal salt solution, an oxygenated polymer or a ceramic material as defined above regarding the use as an additive of an impregnated organoboron covalent framework according to the invention.

The composition preferably comprises at least 0.2% by weight of the impregnated organoboron covalent organic framework relative to the total weight of the composition, preferably an amount greater than or equal to 0.5% by weight, preferably between 0.5% and 50% by weight.

The present invention therefore also relates to a solid separator for an all-solid-state battery comprising an impregnated organoboron covalent framework according to the invention.

The separator according to the invention is as defined above.

The present invention therefore also relates to an all-solid-state battery electrode comprising an impregnated organoboron covalent framework according to the invention.

The electrode can be positive or negative.

The positive electrode comprising the impregnated organoboron covalent framework according to the invention further comprises a positive electrode active material, and optionally a binder and/or a conductive additive. These components are as defined above.

The negative electrode comprising the impregnated organoboron covalent framework according to the invention further comprises a negative electrode active material, and optionally a binder and/or a conductive additive. These components are as defined above.

The positive or negative electrode may further comprise a current collector, for example an aluminum or copper strip, or a conductive carbon or polymer layer, such as poly(3,4-ethylenedioxythiophene).

The present invention further relates to an all-solid-state battery comprising an impregnated organoboron covalent framework according to the invention.

The all-solid-state battery can be of the Li-ion type, primary Li (non-rechargeable), Li metal (rechargeable or not), dual-ion double electrolyte, Na-ion, K-ion, Mg-ion, Ca-ion or Na-metal, preferably in an Li-ion, primary Li and Li metal type battery.

An all-solid-state battery comprises a positive electrode, a negative electrode and a separator.

As explained above, the impregnated organoboron covalent framework according to the invention may be present in the battery separator and/or in the positive electrode and/or in the negative electrode. These elements are independently as defined above.

The invention will now be described using non-limiting examples.

### FIGURES

FIG. 1 is a set of FT-IR spectrograms (between 500 and 1750 cm⁻¹) compared between (from top to bottom): ABDB, COF-5, lithium salt and COF-5 impregnated with said lithium salt (Li/B molar ratio=1), for the cases where the lithium salt is a) LiClO₄, b) LiBr c) LiTFSI and d) LiI.

FIG. 2 is a set of FT-IR spectrograms (between 500 and 4000 cm⁻¹) compared between (from top to bottom): ABDB, COF-5, lithium salt and COF-5 impregnated with said lithium salt (Li/B molar ratio=1), for the cases where the lithium salt is a) LiClO₄, b) LiBr c) LiTFSI and d) LiI.

FIG. 3 is a set of FT-IR spectrograms comparing COF-1 and COF-1 impregnated with LiI (Li/B ratio=2).

FIG. 4 is a set of FT-IR spectrograms comparing COF-10 and COF-10 impregnated with LiI (Li/B ratio=2).

FIG. 5 is a set of EIS spectrograms of COF-5-based impregnated organoboron covalent frameworks, as a function of the Li/B ratio, in the case where the lithium salt is a) LiClO₄ (left) or b) LiTFSI (right).

FIG. 6 is a set of EIS spectrograms of COF-1 or COF-5-based organoboron covalent frameworks impregnated with LiI (molar ratio Li/B=2), and comparison with LiI alone.

FIG. 7 is a set of EIS spectrograms of COF-10 or COF-5-based organoboron covalent frameworks impregnated with LiI (molar ratio Li/B=2), and comparison with LiI alone.

FIG. 8 is two galvanostatic cycling curves of a battery comprising a lithium salt-based solid electrolyte wherein the separator comprises the impregnated COF COF-5@LiI (left), or wherein the separator comprises only LiI (right).

FIG. 9 is a galvanostatic cycling curve of a Li-metal/organic polymer battery (Li-TCNQ as positive electrode) according to Example 4.

FIG. 10 is a galvanostatic cycling curve of a Li-metal/organic COF-5@LiI battery (perylene diimide as positive electrode) according to Example 4.

FIG. 11 shows Fourier Transform Infrared (FT-IR) spectra obtained respectively for a COF-5 organoboron covalent framework with a specific surface area of 2068 m²/g (“COF-5 h”) and a COF-5 organoboron covalent framework with a specific surface area of 405 m²/g (“COF-5 l”).

FIG. 12 shows spectra obtained by electrochemical impedance spectroscopy, at different temperatures (20° C., 30° C., 40° C., 50° C., 60° C., 70° C., 80° C., 90° C. and 100° C.) for a COF-5 organoboron covalent framework with a specific surface area of 405 m²/g impregnated with LiI.

### EXAMPLES

Methods of analysis of the organoboron covalent frameworks and impregnated organoboron covalent frameworks according to the invention

### Infrared (IR) Spectroscopy

The infrared spectra were recorded on a Shimadzu 8400S FTIR spectrometer using an attenuated total reflection analysis accessory (transmission mode-KBr). Infrared spectra were collected between 4000 cm-1 and 500 cm-1.

### Atomic Absorption

Measurements of lithium levels in impregnated organoboron covalent frameworks were performed by atomic absorption using the PERKIN ELMER Analyst 300 spectrometer at a wavelength of 670.8 nm. A hollow cathode (lithium) lamp filled with neon was used as a source, as well as a flame generated by a mixture of air and acetylene for atomization. A direct calibration was performed with three solutions of concentration at 1, 2 and 3 ppm prepared from a commercial standard solution at one mol·L⁻¹ in Li⁺. The sample was prepared to a concentration of 2 ppm Li⁺ and then analyzed as an unknown concentration. The absorbance value obtained is compared to the calibration curve made beforehand in order to obtain the actual concentration of Li⁺ and therefore the lithium level associated with the compound. Each sample was analyzed three times to validate the lithium level found.

### NMR

The spectrometer used is the BRUKER AVANCE III HD 500 MHz SB equipped with a CP_MAS solid-state probe and an Ultra Shield magnet of 11.7 T. The samples are loaded into a 4 mm ZrO₂ rotor.

The ¹³C, ¹¹B and ⁷Li NMR spectra with cross-polarization and magic angle spinning (CP-MAS) were recorded at a rotational speed of 15 kHz. The chemical shifts of ¹³C are referenced to 17.3 ppm hexamethylbenzene as standard.

### BET

The analysis of N₂ gas adsorption isotherms was performed using an ASAP 2020 Micromeritics porosimetry analyzer. The measurement was carried out at 77 K (liquid N₂ bath) on 300 mg samples degassed and activated before and after lithium salt impregnation.

### Example 1: Preparation of Different Organoboron Covalent Frameworks

Various organoboron covalent frameworks were prepared according to the following protocols

### 1.1. Synthesis of COF-5

In a 500 mL flask, 784 mg of hexahydroxytriphenylene (HHTP, supplier: TCI) and 602 mg of benzene diboronic acid ((“ABDB”), supplier: Sigma Aldrich, Merck) were added, previously ground and dried under vacuum at room temperature overnight.

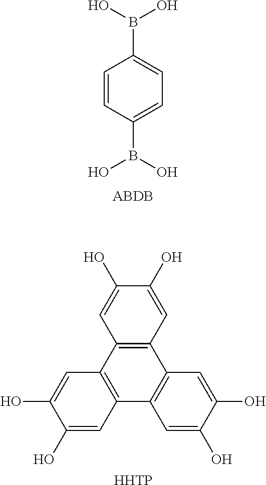 [SMILES: OB(O)c1ccc(B(O)O)cc1 ; Oc1cc2c3cc(O)c(O)cc3c3cc(O)c(O)cc3c2cc1O ; "HHTP"]

1.47 mL of methanol is added to this mixture, then 301 ml of a mixture 1/4 mesitylene/anhydrous 1,4-dioxane. The flask is then placed in an ultrasonic bath for 10 min and then heated at 90° C. under vigorous stirring (≤500 rpm) for 7 days. The greenish gray precipitate obtained is filtered, washed with anhydrous acetone and toluene. The powder is then dried under vacuum for 6 h, then at 70° C. for 6 h and finally at 120° C. for 12 h in a programmable vacuum tubular furnace marketed by Buchi.

The IR and NMR analyses of the product obtained give the following results:
IR (KBr pellet) (cm⁻¹): 1522; 1491; 1450 ν(C═C); 1350 ν(B—O); 1324 ν(B—O); 1240 ν(C—O); 1161 ν(C—H); 1077 ν(C—H); 1026 ν(B—C); 849 ν(C—H); 832; 657; 612 NMR CP MAS ¹³C δ in ppm: 146.72 (C—O); 132.8 (C—B); 123.85 (C═C); 102.98 (C—H_{Ar}) NMR CP MAS ¹¹B δ in ppm: 21.07 (B—O), 13.83 (B—C)

### 1.2. Synthesis of COF-1

200 mg of benzene-1,4-diboronic acid (sigma aldrich, Merck), previously ground by hand then dried under vacuum at room temperature overnight, was added to a dry flask, 40 ml of 1:1 v:v of a mixture of methylene and 1,4-dioxane was added under an inert atmosphere (argon). The mixture was placed in an ultrasonic bath for 5 min then bubbled for 30 min and finally heated to 80° C. for 72 h. A white powder is obtained by centrifugation washed with anhydrous acetone then dried at 65° C. for 6 h then 6 h at 120° C. under BUCHI (yield 82%).

IR (KBr pellet) (cm⁻¹): 1509 ν(C═C); 1398 ν(B—O); 1339 ν(B—O); 1301 ν(C—C); 1107 ν(C—H); 1019 ν(C—H); 711 ν(B₃O₃);

NMR CP MAS ¹³C δ in ppm: 133; 127

NMR CP MAS ¹¹B δ in ppm: 31.82; 32.89.

### 1.3. Synthesis of COF-10

112 mg of HHTP (TCI), 86 mg of biphenyl diboronic acid ABPD (sigma aldrich, Merck) previously ground by hand then dried at room temperature under vacuum overnight and 0.21 ml of MeOH were added to a flask.

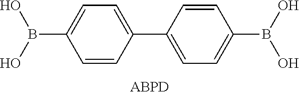 [SMILES: OB(O)c1ccc(-c2ccc(B(O)O)cc2)cc1]

The mixture is dissolved in 43 mL of a 1:4 mesitylene: dioxane mixture then placed in an ultrasonic bath for 1 min then heated to 90° C. under rigorous stirring for 7 days. The solid is isolated by filtration and briefly washed with toluene and then anhydrous acetone. The solid is dried under vacuum at 120° C. overnight (yield 79%).

IR (KBr pellet) (cm⁻¹): 1492; 1449; 1353; 1326; 1241; 1159; 1017; 1006; 848; 834, 810; 726; 650

NMR CP MAS ¹³C δ in ppm: 146.62; 141.38; 134.40; 123.90

NMR CP MAS ¹¹B δ in ppm: 1.09.

1.4. Synthesis of imine-boroxine-COF-1

300 mg of 4-formylphenylboronic acid (FPBA) and 108 mg of 1,4-phenylenediamine (PDA) were added to a 100 mL flask in a solution (40 mL) 1/3 v/v of 1,4-dioxane/mesitylene. The mixture is placed in an ultrasonic bath for 10 min then treated by flash freezing at 77K. The mixture is then degassed under vacuum until it thaws. The operation is repeated 3 times. The reaction mixture is then heated to 120° C. for 3 days. An orange brown precipitate is recovered by filtration, then washed with anhydrous acetone. The product is then immersed in dichloromethane for 3 days, during which the activating solvent was decanted and freshly replaced four times. The orange brown precipitate obtained is dried at room temperature then at 100° C. under vacuum overnight (yield 78%).

IR (KBr pellet) (cm⁻¹): 1656 νC═O); 1626 ν(C═N); 1497 ν(C—H); 1441; 1315 ν(B—O) 1216 ν(B—C); 1019 ν(C—H); 1011; 870; 710 ν(B₃O₃); 631; 532; 504; 474; 442 NMR CP MAS ¹³C δ in ppm: 159 (C═N); 150 (C_{Ar}—N); 139 (CA-C═); 127 (C—B); 116 (C_{Ar}—H).

1.5. Synthesis of imine-boronate-COF-2

A 1/3 v/ν(40 mL) solution of 1,4-dioxane/mesitylene containing 270 mg of 4-formylphenylboronic acid, 105 mg of 1,4-phenylenediamine and 195 mg of hexahydroxytriphenylene is added to a 100 mL flask. The flask is placed in an ultrasonic bath for 10 min and then frozen quickly at 77K. The mixture is then degassed under vacuum until it thaws. The operation is repeated 3 times. The reaction mixture is then heated to 120° C. for 3 days. A greenish precipitate is recovered by filtration, then washed with anhydrous acetone. The product is then immersed in dichloromethane for 3 days, during which the activating solvent was decanted and freshly replaced four times. The greenish brown precipitate obtained is dried at room temperature then at 100° C. under vacuum overnight (yield 79%).

IR (KBr pellet) (cm⁻¹): 1688 ν(C═O); 1608 ν(C═N); 1491 ν(C—H); 1445; 1353 ν(B—O); 1325 ν(B—O); 1241 ν(C—O); 1160; 1062 ν(B—C); 1015; 976; 856; 845; 728 NMR CP MAS ¹³C δ in ppm: 157 (C═N); 149 (C_{Ar}—N); 139 (C_{Ar}—C═); 134 (CAT-H); 124 (C_{Ar}═C_{Ar}), 107 (C_{Ar}—H).

1.6. Synthesis of imine-boroxine-COF-1 SO₃Li

300 mg of FPBA (Sigma aldrich, Merck) and 195.22 mg of 1,4-phenylenediamine-2-sulfonate of lithium (PaSO₃ Li) were added to a 100 mL flask in a solution of 40 ml of 1,4-dioxane/mesitylene (1/3 v/v). The mixture is placed in an ultrasonic bath for 10 min then frozen at 77K. The mixture is then degassed under vacuum until it thaws. The operation is repeated 3 times. The reaction mixture is then heated to 120° C. for 3 days. An orange precipitate is recovered by filtration, then washed with anhydrous acetone. The product is then immersed in DCM for 3 days, during which the activation solvent was decanted and freshly replaced four times. The orange brown precipitate obtained is dried at room temperature then at 100° C. under vacuum overnight (yield 62%).

IR (KBr pellet) (cm⁻¹): 1656 ν(C═O); 1626 ν(C═N); 1497 ν(C—H); 1441; 1315 ν(B—O); 1155 ν(S═O); 1019; 1011; 870 ν(S—O); 833 ν(S—O); 711 ν(B₃O₃); 631; 532; 504; 474; 442 NMR CP MAS ¹³C δ in ppm: 159 (C═N); 146 (C—N); 139 (C—C_{Ar}); 127 (C—B); 117 (C═CH).

1.7. Synthesis of imine-boronate-COF-2 SO₃Li

451 mg of FPBA, 169 mg of 1,4-phenylenediamine-2-sulfonate of lithium and 195 mg of hexahydroxytriphenylene were added to a 100 mL flask in a solution of 40 mL of 1,4-dioxane/mesitylene (1/3 v/v). The mixture is placed in an ultrasonic bath for 10 min then frozen at 77K. The mixture is then degassed under vacuum until it thaws. The operation is repeated 3 times. The reaction mixture is then heated to 120° C. for 3 days. A brown precipitate is recovered by filtration, then washed with anhydrous acetone. The product is then immersed in DCM for 3 days, during which the activation solvent was decanted and freshly replaced four times. The brown precipitate obtained is dried at room temperature then at 100° C. under vacuum overnight (yield 70%).

IR (KBr pellet) (cm⁻¹): 1602 ν(C═N); 1491 ν(C—H); 1445; 1354 ν(B—O); 1334 ν(B—O); 1241 ν(C—O); 1160 ν(S═O); 1106; 1062 ν(B—C); 1015; 981; 833 ν(S—O); 728; 697; 652; 610 NMR CP MAS ¹³C δ in ppm: 157 (C═N); 146 (C_{Ar}—N); 139 (C_{Ar}—C═); 132 (C_{Ar}—H); 124 (C_{Ar}═C_{Ar}); 103.98 (C_{Ar}—H).

### Example 2: Preparation of Different Impregnated Organoboron Covalent Frameworks According to the Invention

100 mg of dry and activated COF are introduced into pill containers. The pill containers are vacuum-sealed, then solutions of different lithium salts prepared with 6 mL of anhydrous acetone are added. The nature and amount of lithium salt is summarized in Table 1 below. The mixture is stirred for 7 days. The acetone is evaporated at room temperature under an inert atmosphere then the different impregnated COF samples are dried under vacuum (about 10 mbar) at room temperature for 4 h, then at 65° C. for 6 h and finally at 120° C. for 14 h.

TABLE 1
LiI (sigma aldrich, Merck), LiBr (sigma aldrich, Merck),
LiClO₄ (TCl), LiTFSI (sigma aldrich, Merck).

| | | | | |
|---|---|---|---|---|
| Li/B molar | | | | |
| ratio | LiClO₄ | LiTFSI | LiI | LiBr |

COF-5@

| | | | | | | | | |
|---|---|---|---|---|---|---|---|---|
| 1/3 | 22.4 | mg | 60.6 | mg | 28.5 | mg | 18.5 | mg |
| 1/2 | 33.7 | mg | 91 | mg | 42.75 | mg | 27.6 | mg |
| 1 | 67.4 | mg | 182 | mg | 85 | mg | 55.2 | mg |
| 2 | 134.8 | mg | 364 | mg | 171 | mg | 101.4 | mg |

COF-1@

| | | | | | |
|---|---|---|---|---|---|
| 2 | — | — | 197 | mg | — |

COF-10@

| 1.65 | — | — | 171 | mg | — |
|---|---|---|---|---|---|
| | Imine-boroxine-COF-1@ | | | | |
| 2 | — | — | 146 | mg | — |
| | Imine-boronate-COF-2@ | | | | |
| 2 | — | — | 104 | mg | — |
| | Imine-boroxine-COF-1 SO₃Li@ | | | | |
| 2 | — | — | 99.8 | mg | — |
| | Imine-boronate-COF-2 SO₃Li@ | | | | |
| 2 | — | — | 79.8 | mg | — |

The Li/B molar ratio was determined by atomic absorption analysis of the impregnated organoboron covalent frameworks. They correspond to the Li/B ratios of the reagents introduced.

### Example 3: Characterizations of the Impregnated Organoboron Covalent Frameworks According to the Invention

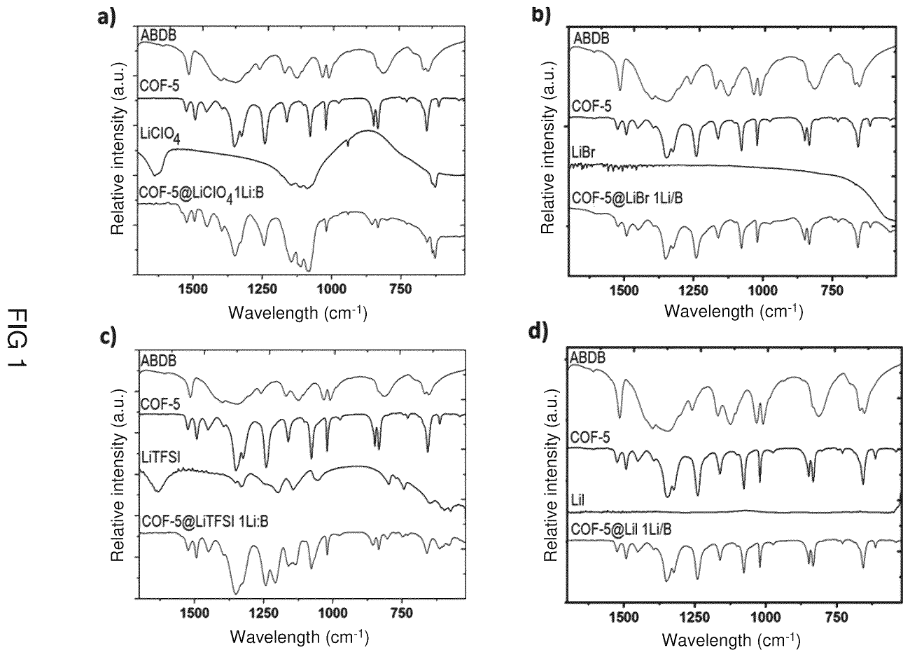

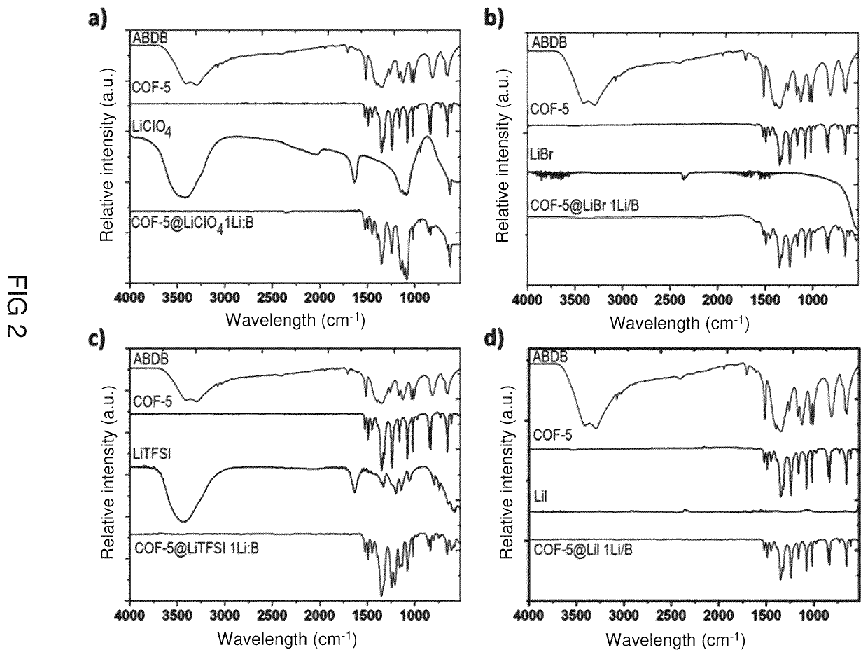

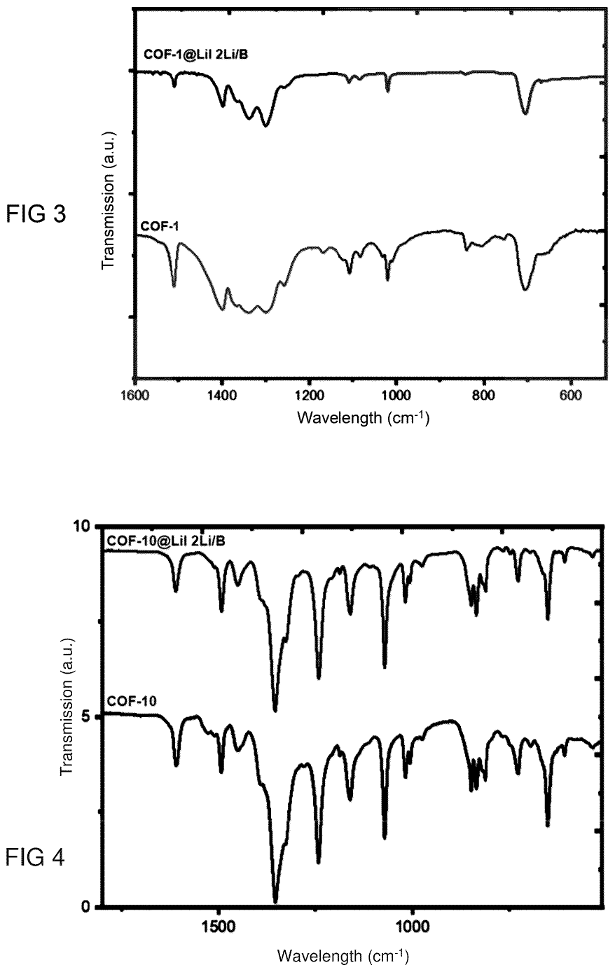

The impregnated organoboron covalent frameworks of Example 2 were characterized by IR spectroscopy and compared with the spectrograms of the COF and the corresponding lithium salt taken each individually (see FIGS. 1 to 4).

The different impregnated COFs were also analyzed by NMR spectroscopy. The results of these two analytical techniques are summarized below:

### COF-5@LiClO₄:

IR (KBr pellet) (cm⁻¹): 1522; 1494; 1448; 1395; 1348 ν(B—O); 1329 ν(B—O); 1243 ν(C—O); 1145 ν(Cl—O); 1110 ν(Cl—O); 1080 ν(B—C); 1018; 853; 832; 655; 636; 626 NMR CP MAS ¹³C δ in ppm: 146.72 (C—O); 133.02 (C_{Ar}—B); 123.85 (C_{Ar}═C_{Ar}); 103.08 (C_{Ar}—H)

NMR CP MAS ¹¹B δ in ppm: 21.38; 7.95

### COF-5@LiTFSI:

IR (KBr pellet) (cm⁻¹): 1521; 1492; 1450; 1349 ν(B—O); 1322 ν(B—O); 1243 ν(C—O); 1200 ν(C—F); 1162 ν(C—F); 1133; 1075 ν(B—C); 1019; 851; 832; 657; 577

NMR CP MAS 13C δ in ppm: 146.60 (C—O); 133 (C_{Ar}—B); 127.86; 123.85; 123.79 (C═C); 102.98 (C—H_{Ar}) NMR CP MAS 11B δ in ppm: 21.69; 9.22

### COF-5@LiI:

IR (KBr pellet) (cm⁻¹): 1523; 1491; 1449; 1350 ν(B—O); 1322 ν(B—O); 1240 ν(C—O); 1159; 1077 ν(B—C); 1019; 848; 832; 655; 613

NMR CP MAS ¹³C δ in ppm: 146.62 (C—O); 133.8 (C—B); 123.76 (C═C); 102.88 (C—H_{Ar})

NMR CP MAS ¹¹B δ in ppm: 20.64; 7.01

NMR CP MAS ⁷Li δ in ppm: 0.32; −4.03 (LiI)

NMR CP MAS ¹²⁷I δ in ppm: 408

### COF-5@LiBr:

IR (KBr pellet) (cm⁻¹): 1523; 1491; 1451; 1350 ν(B—O); 1324 ν(B—O); 1240 ν(C—O); 1159; 1077 ν(B—C); 1021; 848; 832; 657; 611

### Imine-boroxine-COF-1@LiI:

IR (KBr pellet) (cm⁻¹): 1653 ν(C═O); 1622 ν(C═N); 1487 ν(C—H); 1441; 1315 ν(B—O); 1216 ν(B—C); 1019 ν(C—H); 1011; 870; 710 ν(B₃O₃); 631; 533; NMR CP MAS 13C δ in ppm:

### Imine-boronate-COF-2@LiI:

IR (KBr pellet) (cm⁻¹): 1682;1612; 1491; 1448; 1350;1323; 1243; 1160; 1064; 1015; 976; 856; 845; 728; 547

NMR CP MAS ¹³C δ in ppm: 159 (C═N); 147 (C_{Ar}—N); 137 (C_{Ar}—C═); 134 (CAT-H); 124 (C_{Ar}═C_{Ar}), 107 (C_{Ar}—H).

The N₂ gas adsorption isotherms were also performed for some impregnated organoboron covalent frameworks of Example 2.

From these curves, the specific surface areas, expressed in m²/g, were determined for each impregnated COF and are shown in Table 2 below.

TABLE 2

Specific surface area in m²/g
COF-5@

| | LiClO₄ | LiTFSI | LiI | LiBr |
|---|---|---|---|---|
| 1Li/3B | 575 | 410 | 1320 | 1555 |
| 1Li/2B | 397 | 298 | 1117 | 1273 |
| 1Li/B | 288 | 122 | 956 | 1062 |
| 2Li/B | 157 | 67 | 663 | 842 |

### Example 4: Electrochemical Analyses of the Impregnated Organoboron Covalent Frameworks According to the Invention

### Material and Methods

### Preparing the Samples

All experiments were conducted under a dry argon atmosphere in a glove box (O₂ and H₂O<3 ppm). The powders dried at 120° C. for 8 h, were cold-pressed at about 120 MPa for 1 min to obtain pellets for electrochemical tests, also referred to as “electrolyte” in the remainder of this example. These were carried out at 70° C., except for measurements by electrochemical impedance spectroscopy.

### Electrochemical Impedance Spectroscopy

Electrochemical impedance spectroscopy (EIS) measurements were performed with an MTZ-35 (BioLogic) frequency response analyzer coupled to an intermediate temperature system (ITS), controlling the sample temperature by Peltier effect. An electrolyte pellet with a diameter of 6 mm and a thickness of 0.7 mm is sandwiched between two blocking electrodes for the conductive ion (30 mg; 120 MPa). This metal/electrolyte/metal type device allows only the behavior of the electrolyte on the impedance spectrum to be observed (blocking electrode: Al).

AC impedance spectra are recorded in the frequency range 30 MHz to 0.1 Hz with an excitation signal of 0.05 V amplitude. Measurements are made between 20° C. and 100° C. in heating and cooling (1° C./min), with temperature stabilization for 15 min before each impedance measurement.

Ionic conductivity (o) was determined according to the following equation: σ_{ionic}=I/(R*A) after modeling and simulating the EIS data using the equivalent circuit model, where I is the pellet thickness, R is the resistance, and A is the surface in contact with the electrodes with A=πr² and r is the radius. The activation energy (Ea) was determined from the slope of the Arrhenius graph. The device is mounted in a sample holder which is itself placed inside the hermetic cell (Controlled Environment Sample Holder, CESH, BioLogic).

### Cyclic and Linear Sweep Voltammetry

This type of measurement is used to validate the proper functioning of the electrolyte in terms of conductivity of Li ions by observing the reversibility of the system Li⁺+e⁻=Li around OV but also its possible electrochemical degradation by evaluating the parasitic currents in oxidation and in reduction which are visible over the entire range evaluated beforehand determined by linear sweep voltammetry. Linear Sweep Voltammetry (LSV) is a simple electrochemical technique. The linear sweep voltammetry method is similar to cyclic voltammetry, but instead of performing a linear cycle over the potential range in both directions, linear sweep voltammetry involves a single linear sweep from the lower potential limit to the upper potential limit.

This time, the thickness of the electrolyte was thinner than previously at 100 μm, in order to avoid distortion of the voltammogram due to the ohmic drop effect. An asymmetric cell assembly of the (−) Li⁰/electrolyte/stainless steel (+) type was used, where the study of the reversible lithium metal deposition takes place on the stainless steel which will be the positive terminal of the potentiostat.

Typically, a sweep rate of 0.1 mV s⁻¹ in a voltage range of −0.5 to 5.0 V (relative to Li/Li⁺) was applied to obtain the different chronoamperograms.

### Study of the Reversibility of the Li⁺/Li Electrochemical System by Galvanostatic Cycling

This measurement is also used to validate the proper functioning of the electrolyte in terms of ion conductivity of Li ions by observing the reversibility of the system Li⁺+e⁻=Li around OV.

A symmetric cell (Li⁰/electrolyte/Li⁰) was cycled over a plurality of cycles between +15 mV and −15 mV at current densities of 0.1 mA/cm², 0.2 mA/cm² and 2 mA/cm². Here too, the thickness of the electrolyte was about 100 μm.

### Results

### 1. Conductivity Measurement

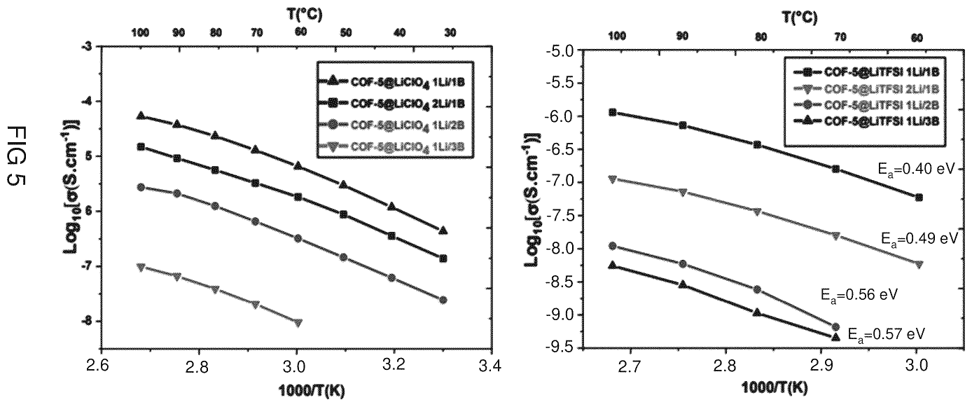

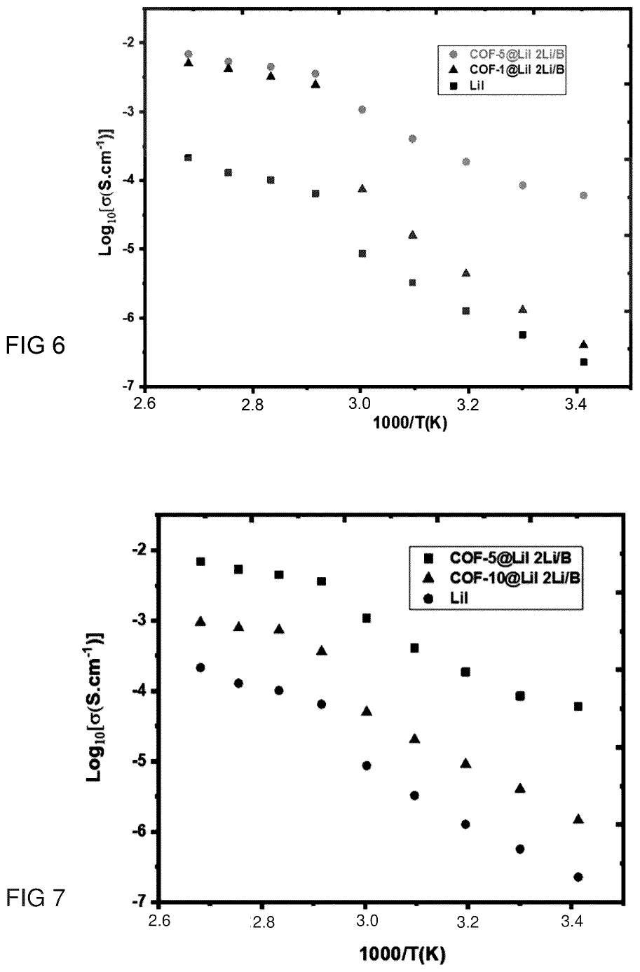

FIGS. 5 to 7 show the EIS spectrograms of COF-5, COF-1 or COF-10-based impregnated organoboron covalent frameworks, as a function of the Li/B ratio.

Table 3 below summarizes the conductivity values at 20° C. and 100° C. of different impregnated COFs according to the invention.

TABLE 3

Conductivity at 20° C./100° C. (S · cm⁻¹)

| | | | |
|---|---|---|---|
| LiClO₄ | LiTFSI | LiI | LiBr |

COF-5@

| | | | | |
|---|---|---|---|---|
| 1Li/3B | —/ | —/ | Not available | Not available |
| | 1.10⁻⁷ | 5.10⁻⁹ | | |
| 1Li/2B | 3.10⁻⁸/ | —/ | Not available | Not available |
| | 5.10⁻⁶ | 1.10⁻⁸ | | |
| 1Li/B | 6.10⁻⁷/ | 7.10⁻⁸/ | 5.10⁻⁶/ | —/ |
| | 8.10⁻⁵ | 1.10⁻⁶ | 1.10⁻⁴ | 5.10⁻⁸ |
| 2Li/B | 2.10⁻⁷/ | 1.10⁻⁸/ | 1.10⁻⁴/ | 3.10⁻⁶/ |
| | 2.10⁻⁵ | 1.10⁻⁷ | 1.10⁻² | 5.10⁻⁵ |

| | |
|---|---|
| | COF1@LiI |
| 2Li/B | 3.10⁻⁷/5.10⁻³ |
| | COF10@LiI |
| 2Li/B | 1.10⁻³/1.10⁻⁶ |
| | Imine-boroxine-COF-1@LiI |
| 2Li/B | 5.10−5/4.10⁻⁸ |
| | Imine-boronate COF-2@LiI |
| 2 | 1.10⁻⁸ |
| | Imine-boroxine-COF-1 SO₃ Li@LiI |
| 2 | 4.10⁻⁸/5.10⁻⁵ |
| | Imine-boronate-COF-2 SO₃ Li@LiI |
| 2 | 3.10⁻⁶/9.10⁻⁶ |

These results show that the impregnated organoboron covalent frameworks according to the invention have conductivity making them usable as electrolytes in batteries. Some values are comparable to other electrolyte materials known as ceramic materials.

### 2. Battery Testing

First, the COF-5@LiI impregnated COF was tested as a separator. The following two batteries were prepared: one with an electrolyte composed only of anhydrous LiI and the second which includes a layer of COF-5@LiI (2Li/B) in the center of the electrolyte composed of anhydrous LiI. Lithium metal and Li-TCNQ were used as negative and positive electrodes, respectively.

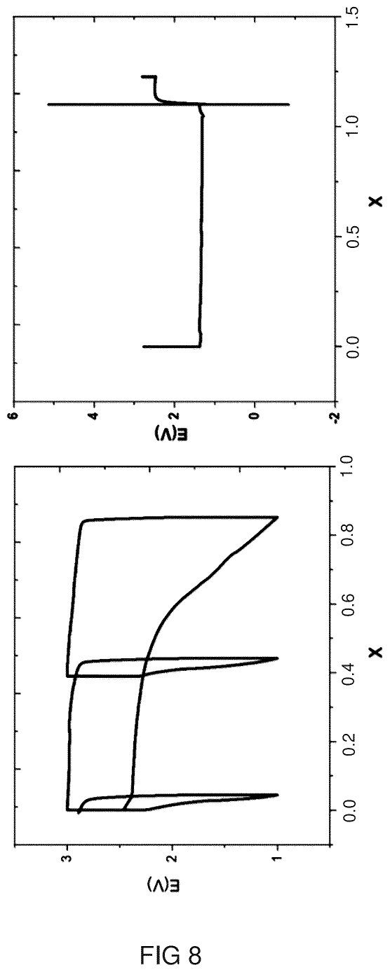

These two batteries were then tested in galvanostatic mode with potential limitation. It should be noted that the battery having only LiI as electrolyte/separator shows no electrochemical activity (FIG. 8 on the right). Conversely, the one including the object of the present invention shows the electrochemical profile of the positive electrode material, located at 2.4/3V vs Li (FIG. 8 on the left).

In a second step, a battery (Li-TCNQ and Li-metal as positive and negative electrode respectively) comprising COF-5@LiI as an additive was prepared by incorporating COF-5@LiI into a PEO-type polymer matrix.

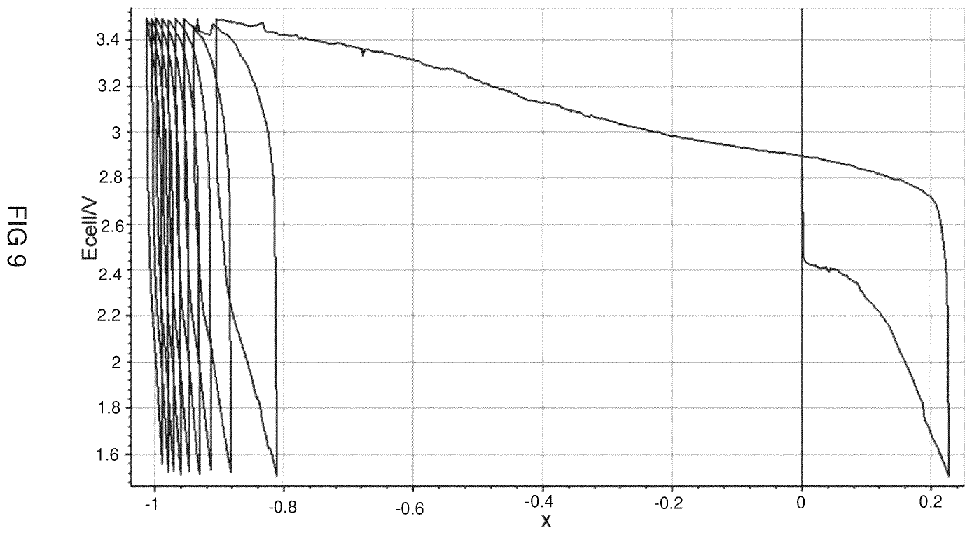

This battery was tested by galvanostatic cycling with potential limitation. The curve obtained is shown in FIG. 9.

These results show that the presence of COF-5@LiI in the electrolyte facilitates the transport of lithium ions and allows the electrochemical profile of the positive electrode material to be obtained.

In a third step, a battery (Perylene-diimide and Li-metal as positive and negative electrode respectively) comprising COF-5@LiI as a solid electrolyte (compressed pellet) was prepared.

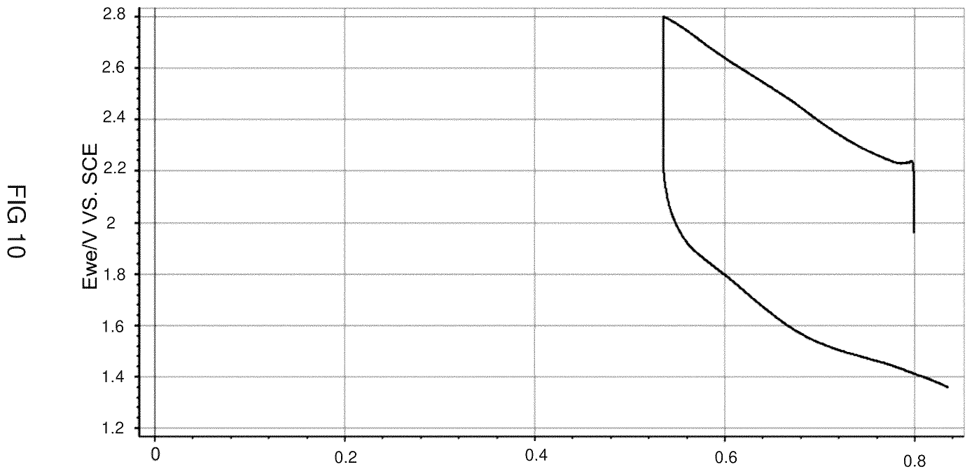

This battery was tested by galvanostatic cycling with potential limitation. The curve obtained is shown in FIG. 10.

These results show that COF-5@LiI, used directly as an electrolyte, makes it possible to obtain the electrochemical profile of the positive electrode material and thus the solid organic Li-metal battery design.

### Example 5: COF-5 Organoboron Covalent Framework with Less Specific Surface Area Impregnated with LiI

### Preparing the COF-5

1 g HHTP (i.e. 3.08.10-3 mol) and 0.770 g ABDB (i.e. 4.63. 10⁻³ mol) are ground together in a zirconium crucible before being dried overnight (80° C. at reduced pressure). 3 ml of methanol (synthesis grade) then a 1:4 volume mixture of mesitylene: 1,4-dioxane (i.e. 77:307 ml) is added to the precursors. The flask is placed in an ultrasonic bath for 10 min then heated to 90° C. under very vigorous stirring (well above 500 rpm). After 7 days of stirring, the reaction mixture is filtered. The recovered solid is then washed three times with acetone.

The COF-5 obtained has a specific surface area of 405 m²/g.

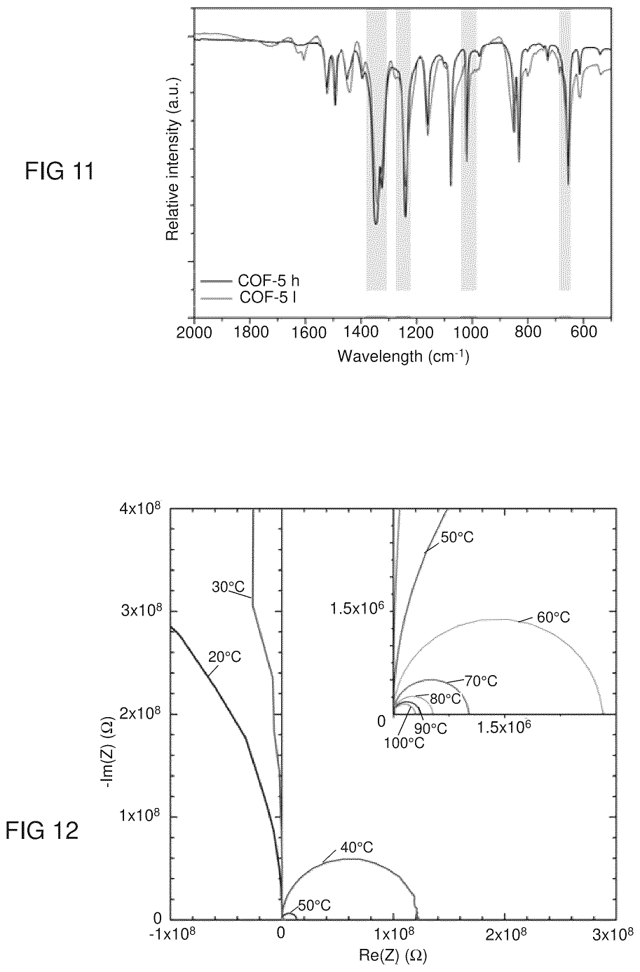

The FT-IR spectrum obtained for this COF is shown in FIG. 11 (“COF-5 1”). By way of comparison, this figure also shows the FT-IR spectrum of a COF-5 as obtained according to the protocol described in point 1.1 above, with a specific surface area of 2068 m²/g.

### LiI Impregnation

The COF-5 is impregnated with a lithium iodide solution, to obtain a surface dispersion on the COF of 0.83 mg LiI per m². For this purpose, 168.1 mg of lithium iodide is used for 1 g of COF.

The impregnation protocol is identical to that described above. As a reminder, the LiI is dissolved in 7 ml of dry acetone. The COF-5 is suspended in this solution with stirring for 7 days and the solvent is then evaporated. The compound is rigorously dried under vacuum in a plurality of steps as described above.

The Li/B ratio of the impregnated COF obtained is equal to 0.2.

### Conductivity Measurements by Electrochemical Impedance Spectroscopy

The resistivity measurements, carried out as described in Example 4 above, reveal the absence of conductivity at 20° C. and 30° C. The conductivity is observed, and becomes measurable, from 40° C. and up to 100° C. The values obtained are between 9.81.10-9 S·cm⁻¹ (at 40° C.) and 3.95.10-6 S·cm⁻¹ (100° C.).

What is claimed is:

1. An organoboron covalent organic framework impregnated with at least one salt selected in the group consisting of alkali metal salts and alkaline-earth metal salts, the impregnated organoboron covalent organic framework being substantially free of organic solvent.

2. The impregnated organoboron covalent organic framework according to claim 1, wherein the salt is a lithium salt.

3. The impregnated organoboron covalent organic framework according to claim 1, wherein the salt is a salt of formula MX₁, M being a metal cation selected from the group consisting of alkali metal cations and alkaline-earth metal cations, and X₁ being an anion comprising at least one halogen.

4. The impregnated organoboron covalent organic framework according to claim 1, wherein the salt is lithium iodide.

5. The impregnated organoboron covalent organic framework according to claim 1, wherein the molar ratio between the molar amount of alkali metal or alkaline-earth metal and the molar amount of boron is between 0.05 and 10.

6. The impregnated organoboron covalent organic framework according to claim 1, wherein the organoboron covalent organic framework has the following formula (I): 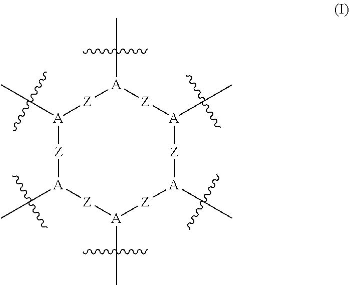
wherein
A is a monocyclic or polycyclic organoboron moiety, possibly substituted,
Z is a monocyclic or polycyclic organic moiety, possibly substituted,
and wherein each A-Z bond is a carbon-boron bond, or
wherein the organoboron covalent organic framework has the following formula (II): 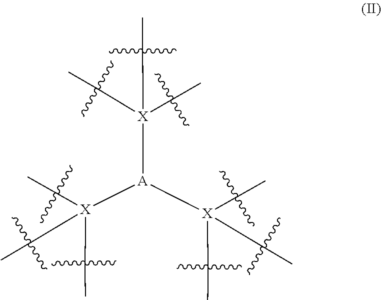
wherein
A is a monocyclic or polycyclic organoboron moiety, possibly substituted,
X is a monocyclic or polycyclic organic moiety, possibly substituted,
and wherein each A-X bond is a carbon-boron bond, or
wherein the organoboron covalent organic framework is a spiroborate and has the following formula (III): 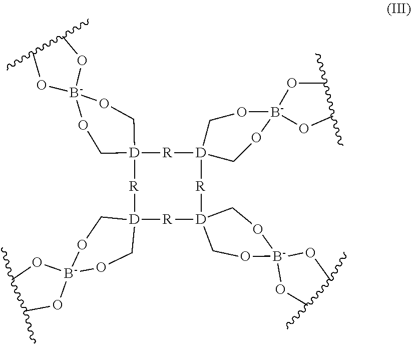
wherein
D is a monocyclic or polycyclic organic moiety, possibly substituted, and
R is a linear organic moiety, possibly substituted, and
M′⁺ is a cation selected from the group consisting of metal, alkali metal or alkaline-earth metal cations.

7. The impregnated organoboron covalent organic framework according to claim 6, wherein the organoboron covalent organic framework has formula (I).

8. The impregnated organoboron covalent organic framework according to claim 6, wherein the moiety A is selected from the group consisting of a moiety of formula (A-1) 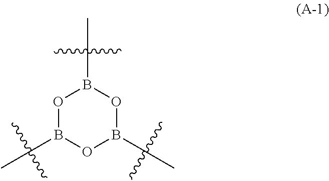 [SMILES: *B1OB(*)OB(*)O1]
and a moiety of formula (A-2) 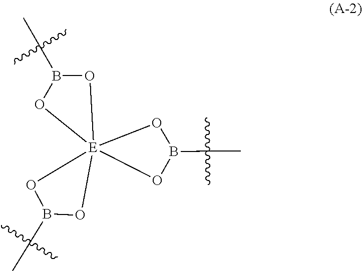
wherein E is a monocyclic or polycyclic, possibly substituted, preferably aromatic, hydrocarbon moiety.

9. The impregnated organoboron covalent organic framework according to claim 6, wherein the moiety Z comprises one or more, optionally substituted, 6-membered aromatic hydrocarbon rings, and when it comprises a plurality of rings, each ring is independently fused with one or more of the other rings and/or separated from the other ring(s) by at least one chemical bond.

10. The impregnated organoboron covalent organic framework according to claim 1, wherein the organoboron covalent organic framework is selected from the group consisting of COF-1, COF-5 and COF-10.

11. A method for preparing an impregnated organoboron covalent framework according to claim 1, comprising the following steps:
a step of supplying an organoboron covalent framework,
a step of adding to the organoboron covalent framework a salt selected from the group consisting of alkali metal salts and alkaline-earth metal salts, said salt being in solution in an organic solvent, and obtaining a mixture,
a step of stirring the mixture, and
a step of removing the organic solvent by drying the mixture, said drying being fractionated into at least one first drying step and a second drying step.

12. The method according to claim 11, wherein the first drying step is performed at a temperature between 15° C. and 30° C., and the second drying step is performed at a temperature between 40° C. and 180° C.

13. A solid electrolyte in an all-solid-state battery, which is an impregnated organoboron covalent framework according to claim 1.

14. An additive in an electrolyte composition, which is an impregnated organoboron covalent framework according to claim 1.

15. An electrolyte composition, comprising an impregnated organoboron covalent framework according to claim 1.

16. A solid separator for an all-solid-state battery comprising an impregnated organoboron covalent framework according to claim 1.

17. An electrode for an all-solid-state battery comprising an impregnated organoboron covalent framework according to claim 1.

18. An all-solid-state battery comprising an impregnated organoboron covalent framework according to claim 1.
